(19) United States
(12) Patent Application Publication
(10) Pub. No.: US 2002/0142734 A1
(43) Pub. Date: Oct. 3, 2002

(54) Miniaturized wrist phone

(76) Inventor: James Wickstead, Cedar Knolls, NJ (US)

Correspondence Address: VOLPE AND KOENIG, P.C., SUITE 400, ONE PENN CENTER, 1617 JOHN F. KENNEDY BOULEVARD, PHILADELPHIA, PA, 19103, US

(21) Appl. No.: 09/824,828

(22) Filed: Apr. 3, 2001

(51) Int. Cl. H04B 1/38

(52) U.S. Cl. 455/90; 455/11.1; 455/66; 455/74

(57) ABSTRACT

Mobile, wireless communications apparatus for transmitting and receiving voice and data signals and being divided into first and second units arranged to be spaced apart but normally operated within a close range and each having a low power transceiver for communication between the first and second unit over a low power radio link. The first unit has a more powerful transmitter and an antenna for receiving and transmitting signals to a remote location, typically through a base station forming part of a cellular network. The second unit is significantly smaller than the first unit and incorporates miniaturized elements including a display, key pad, microphone speaker and micro controller, together with the aforementioned low power transceiver. The battery supply in the second unit is significantly smaller than that provided in the first unit, the second unit being designed to be a size of the order of a conventional wrist watch and being capable of being worn on the wrist of a user. Voice and data are communicated from the second unit and the first unit through the low power transceivers and low power radio link, the first unit relaying said signals to a remote location through a cellular network or a communications satellite. The first unit which is preferably the size of the order of present day cellular phones small enough to be carried in a pocket book, nap-sack, fanny-pack or even glove compartment of an automobile while providing a wrist mountable second unit which is small, light-weight and convenient to use and yet capable of communicating with a cellular network through the first unit by way of a low power radio link.

### BACKGROUND

The present invention relates to wireless mobile phones and, more particularly, to a novel miniaturized wireless mobile phone small enough to be worn on a wearer's wrist and cooperating with a wireless mobile transceiver through lower-powered transceivers which make possible, the small, compact size of the wireless wrist phone.

Miniaturization of electronic devices has been along standing objective within all disciplines of technology, including, but not limited to the telephone field and, especially wireless, mobile telephones. Although the comic strip character Dick Tracy utilized the wrist telephone as a somewhat common place item, technology has yet to catch up with the pious wishes of Dick Tracy afficionados. Although it is technically feasible to provide a wrist telephone employing today's technology, the size and weight of such a wrist telephone cannot be reduced to the size and weight of present day wrist watches due to the presently available size and weight of the components required to be provided within a wrist telephone, which components include a display panel, a key pad, a microphone/speaker, a micro controller, transceiver powerful enough to communicate with a base station and a suitable antenna for transmitting and receiving signals as well as a battery having a capacity sufficient to power the device.

Even though wireless telephones have been significantly reduced in size and weight, since their initial introduction up to the present date, such devices are too bulky and heavy to be comfortably worn as a wrist telephone.

### BRIEF DESCRIPTION OF THE INVENTION

The present invention permits the realization of a wrist telephone in a truly compact size and lightweight, made possible by a division of functions of a conventional wireless mobile telephone into a “head end” worn on the wrist like a watch or watch/calculator and the back end which incorporates all of the capabilities of a traditional digital telephone in which the display and key pad is preferably removed, the “back end” being separated from the head end and carried, for example, on the body of the wrist telephone wearer and communicating with the wrist telephone by means of low-powered transceivers respectively provided in both the head end and back end units. The back end unit may be worn on a belt, stored in a pocket, purse, fanny pack or back pack, briefcase or other carrying case or alternatively may be stored within the glove compartment of a car.

The wrist mounted unit performs all of the conventional functions, such as dialing, transmission of speech and so forth. The wrist unit transmits the appropriate signals to the “back unit” through the cooperating low-power transceivers, the back unit relaying signals to a base unit, for example, and receiving signals from the base unit and relaying these signals through the low power transceivers to the wrist telephone. The separation into two units eliminates the need for a larger more powerful transmitter and battery as part of the wrist telephone and provides an added safety feature of significantly displacing the conventional mobile telephone transceiver from the user's ear and head which reduces, if not eliminates, the possibility of any physical danger due to electromagnetic radiation transmitted by the mobile telephone unit.

It is therefore one object of the present invention to provide a wireless mobile telephone unit of a design so that its miniaturized size equates to that of a wrist watch enabling it to be comfortably worn on the wrist.

Still another object of the present invention is to provide a novel wireless mobile phone comprising a miniaturized unit capable of being worn on the wrist and communicating with a wireless mobile “back unit” capable of communicating with a base station within a cellular telephone network. The wrist unit and “back unit” communicating with one another through cooperating low power transceivers, the “back unit” making it possible to provide a small, compact wrist unit.

### BRIEF DESCRIPTION OF THE DRAWING

The above, as well as other objects of the invention will become apparent when reading the accompanying description and drawing in which:

FIG. 1 is a simplified block diagram showing a wireless mobile wrist telephone designed in accordance with the principles of the present invention.

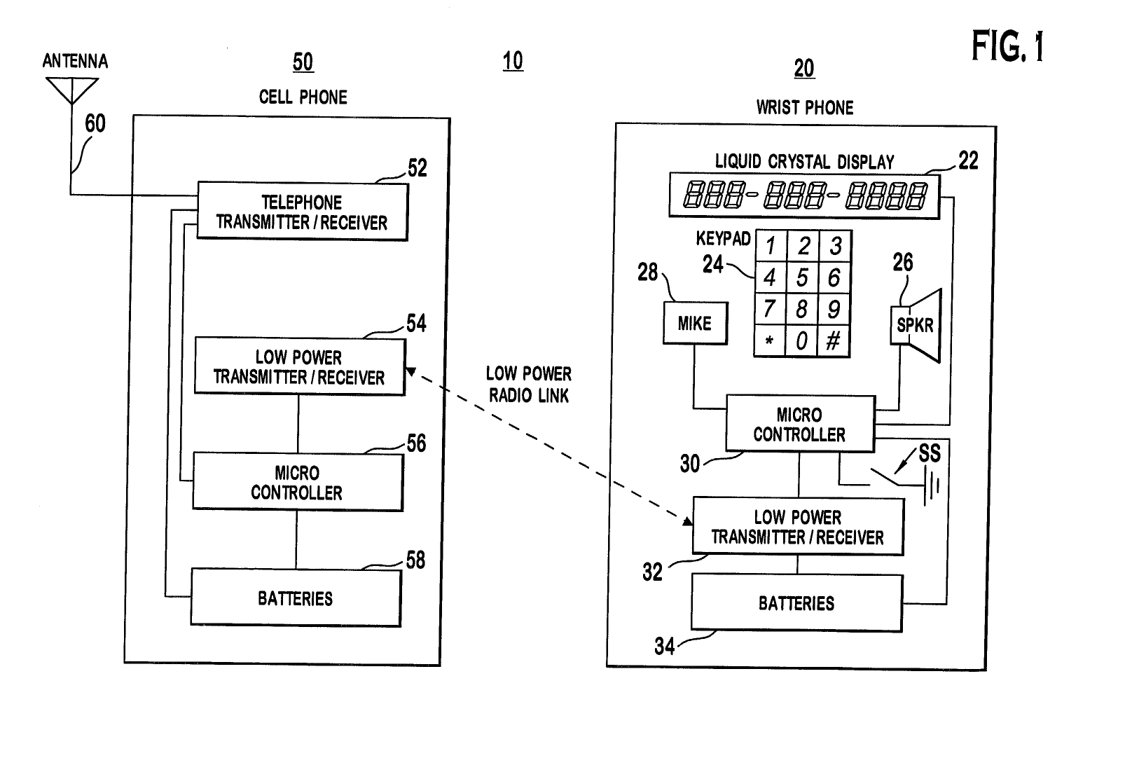

### DETAILED DESCRIPTION OF THE PREFERRED EMBODIMENT(S)

The sole Figure of the present application shows a wireless mobile phone apparatus 10 comprised of a wrist phone unit 20 and a cell phone unit 50. The wrist phone 20 is small and is approximately the size of existing wrist watch/calculators and includes a liquid crystal display 22, key pad 24 for dialing, as well as other functions normally incorporated within a conventional mobile phone, speaker 26, microphone 28, micro controller 30, low power transceiver 32 and a portable battery 34 sufficient for powering the components within wrist phone 20.

The cell phone 50, which is a self-contained unit referred to as the “tail end” of the device, includes a telephone transceiver 52 which communicates with a conventional base station through antenna 60, a low power transceiver 54, a micro controller 56 and a battery pack 58 for powering the components within the cell phone 50.

The wrist phone transceiver 32 communicates with the cell phone transceiver 54 through a low power radio link made possible due to the fact that the spacing between wrist phone 20 and cell phone 50 will typically of the order of several feet or less.

Typically, wrist phone 20 will be worn on the wrist of the user and cell phone 50 can be worn on the wearer's belt, be contained within the pocket of the wearer or in a purse, knap sack or “fanny” pack, for example. The conventional LCD and key pad normally provided within a cell phone can be omitted since these components are provided within the wrist phone unit 20.

The operation of the device is as follows:

In order to make a conventional telephone call, the wrist phone 20 and cell phone 50 are activated by conventional means such as an off/on button (not shown for purposes of simplicity) for coupling the battery sources 34 and 58 to the electronic within each unit 20 and 50, respectively. A conventional call is made by operating the key pad 24, the individual numbers being displayed within the LCD 22 as each number is entered. A send button (not shown for purposes of simplicity) is operated to close send switch SS, activating micro controller 38 to transmit the number displayed in LCD 22 through transceiver 32 in unit 20 to transceiver 54 in unit 50. Micro controller 56 controls the telephone transceiver 52 to transmit the number of the called party through antenna 62 to a base station (not shown for purposes of simplicity) within a cellular telephone network.

When the called party answers, the digital signal from the called party is received by transceiver 52, is transmitted by transceiver 54 through the low power radio link to transceiver 32, the speech signal being coupled to speaker 26.

The device may receive a signal from a called party received by antenna 60 decoded by the transceiver 52 and transmitted through transceiver 54 and the low-power radio link to transceiver 32, the speech signal being coupled to speaker 26, upon appropriate conversion to analog form. Microphone 28 is utilized to provide a two-way communication, as is conventional. Although the apparatus shows a separate microphone 28 and speaker 26, a combined speaker/microphone may be utilized, if desired.

The low-power radio link coupled with the low-power requirements of the components within wrist phone 20 permits the use of a small battery.

The cell 50 may utilize a larger battery pack as is conventional with present day wireless, digital mobile phones. It should be understood, however, that the present invention may be utilized in digital or analog, wireless mobile phones.

By dividing the functions and circuitry between two units 20 and 50, the primary unit employed during the initiation of a communication link and during a speech communication interval with a called (or calling) party, the unit 20 is lighter in weight and easier to use and hold than conventional mobile phones while the high-powered “back-end” 50 located at a position well removed from the ear and especially the head of the user, significantly reducing the exposure of the user's head to electromagnetic radiation. The wireless communication between units 20 and 50 permit a variation in the separation distance between units 20 and 50 without any effect upon the transmission capability, thus providing an extremely light weight, wrist phone which is convenient to use and yet retains all of the attributes of a conventional wireless, mobile phone without providing the power and size in weight of the conventional mobile phone components within a wrist phone. The low-power transceivers may be designed to transmit over a range of less than 100 feet and preferably less than 20 feet. The transceivers may operate at a carrier frequency chosen to be different from other units provided within the area. The back unit may communicate with a base station of a cellular telephone network or communicate with a communications satellite.

If desired, the unit 20 may be worn at other locations, such as the arm, leg, kept in a breast pocket, pant pocket or the like or may clip to a belt or the like and moved to the users mouth when ready to speak. The unit 50 is preferably maintained removed from the users' head to reduce the harm from radiation when in use.

What is claimed is:

1. Wireless apparatus for communicating with a remote location through a wireless network, comprising:
first and second units each having a low-power transceiver for wireless communication over a low power radio link;
said first unit having a second transceiver for wireless communication with said remote location, said second transceiver having a transmission range greater than said low-power transceiver;
said second unit being smaller than said first unit and being of a size so as to be worn or carried on the body of a user;
said second unit having a key pad for inserting calling data;
a display in said second unit displaying calling data;
said second unit having a microphone for converting speech into electrical signals and a speaker for converting electrical signals into speech and a controller for controlling operations of said display, speaker and microphone and coupling electrical signals to the low-power transceiver in said second unit for transmission to said first unit through said low-power radio link.

2. The apparatus of claim 1 wherein said first unit comprises a controller for transferring signals received by the low-power transceiver in said first unit to said second transceiver for transmission to said remote location.

3. The apparatus of claim 1 wherein the controller in said fist unit further includes means for transferring signals from said second transceiver to the low-power transceiver in said first unit for transmission over said low-power radio link to said second unit.

4. The apparatus of claim 1 wherein said low-power transceivers both operate at a specific carrier frequency to prevent receipt of a transmission from a transmitter other than the low-power transceivers in said first and second units.

5. The apparatus of claim 1 wherein the transmission range of said low-power transceiver is less than 100 feet.

6. The apparatus of claim 5 wherein the transmission range is less than 20 feet.

7. The apparatus according to claim 1 wherein the first and second units are powered by portable batteries, a battery source in said second unit being smaller and lower powered than the battery source in said first unit to reduce the overall size of said second unit.

8. The apparatus according to claim 1 wherein said low powered transceivers encode their transmissions to prevent interception by other transceivers.

9. The apparatus according to claim 1 wherein said second transceiver is a digital wireless transceiver.

10. The apparatus according to claim 1 wherein a key pad and display are eliminated from said first unit to reduce electronic components employed in said first unit.

11. The apparatus according to claim 1 wherein said microphone and speaker are combined into one unit.

12. The apparatus according to claim 1 wherein a stylus is provided for operating said key pad.

13. The apparatus of claim 1 wherein the second unit is worn on a wrist of the user.

14. The apparatus of claim 1 wherein the second unit is affixed to an article of clothing of the user.

15. The apparatus of claim 1 wherein the second unit is of a size to enable it to be placed with a pocket of an article of clothing of the user.

16. The apparatus of claim 1 wherein the first unit is maintained at a greater distance from the user's head than said second unit to reduce possible harm due to radiation emitted by said first unit.
